(19) United States
(12) Patent Application Publication
(10) Pub. No.: US 2015/0149246 A1
(43) Pub. Date: May 28, 2015

(54) PROJECTED MAINTENANCE REVENUE FOR FUTURE TIME PERIODS

(71) Applicant: International Business Machines Corporation, Armonk, NY (US)

(72) Inventors: Edward Cannon, Acworth, GA (US); Sue Lynn Chong, Toronto (CA); John J. Dillon, Markham (CA); Dawn M. Fritz, Wake Forest, NC (US); Kurt W. Mueller, Brentwood, TN (US); Nitin Singhal, Charlotte, NC (US)

(73) Assignee: International Business Machines Corporation, Armonk, NY (US)

(21) Appl. No.: 14/088,463

(22) Filed: Nov. 25, 2013

(51) Int. Cl. G06Q 30/02

(52) U.S. Cl. CPC G06Q 30/0202; G06Q 30/0206
USPC 705/7.31

(57) ABSTRACT

A computing device receives a first user input requesting an estimated revenue for a projected time period. The computing device receives a second user input. The computing device determines an expected revenue for the projected time period from new maintenance contracts and renewed maintenance contracts and an expected revenue for the projected time period from warranty upgrades on units based on at least the current number of installed units as of the base time period, the expected number of unit installations for the projected time period, the attrition rate and the warranty option upgrade rate. The computing device determines a total expected revenue for the projected time period based on at least the computing device determining the expected revenue for the projected time period from new maintenance contracts and renewed maintenance contracts and the expected revenue for the projected time period from warranty upgrades on installed units.

### FIELD OF THE INVENTION

The present invention relates generally to business management, and more particularly to projecting maintenance revenue for a defined set of future time periods through the use of inputted inventory baseline, backlog, and transaction rates.

### BACKGROUND

In business, understanding future revenue streams from multi-year maintenance contracts is vital for successful business management. Currently, maintenance projection revenue is based on exhaustive analysis of financial data and market trends to predict the coming year's expected revenue for purposes of budget and target allocations. This solution only provides a short term prediction of the projected revenue for specific unit lines within specific countries and does not adequately recognize the complex business dynamics that affect the annuity stream of maintenance contracts.

### SUMMARY

Embodiments of the present invention provide a system, method, and program product to project maintenance revenue. A computing device receives a first user input requesting an estimated revenue for a projected time period, wherein the projected time period is a time period which is subsequent to a base time period. The computing device receives a second user input, wherein the second user input includes: a current number of installed units as of the base time period, an expected number of unit installations for one or more subsequent time periods to the base time period, a warranty upgrade rate, a warranty capture rate, an attrition rate, and a maintenance contract renewal rate. The computing device determines an expected revenue for the projected time period from new maintenance contracts and renewed maintenance contracts based on at least the current number of installed units as of the base time period, the expected number of unit installations for the projected time period, the attrition rate, the warranty capture rate, and the maintenance contract renewal rate. The computing device determines an expected revenue for the projected time period from warranty upgrades on units based on at least the current number of installed units as of the base time period, the expected number of unit installations for the projected time period, the attrition rate, and the warranty option upgrade rate. The computing device determines a total expected revenue for the projected time period based on at least the computing device determining the expected revenue for the projected time period from new maintenance contracts and renewed maintenance contracts, and the expected revenue for the projected time period from warranty upgrades on installed units.

### BRIEF DESCRIPTION OF THE SEVERAL VIEWS OF THE DRAWINGS

FIG. 1 is a functional block diagram illustrating a projected revenue system in accordance with an embodiment of the present invention.

FIG. 2 depicts a breakdown of potential revenue that may be generated from a contract, in accordance with an embodiment of the present invention.

FIG. 3 is a flowchart depicting the operational steps of the projected revenue system of FIG. 1 in calculating the projected maintenance revenue for a defined set of future time periods through the use of inputted inventory baseline, backlog, and transaction rates, in accordance with an embodiment of the present invention.

FIG. 4 is an illustration depicting the overall process flow and interdependencies between the determinations which form the basis of projecting maintenance revenue for a given year, in accordance with an embodiment of the invention.

FIG. 5 is a block diagram depicting the hardware components of the projected revenue system of FIG. 1, in accordance with an embodiment of the invention.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer-readable medium(s) having computer-readable program code/instructions embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by, or in connection with, an instruction execution system, apparatus, or device.

A computer-readable signal medium may include a propagated data signal with computer-readable program code embodied therein, for example, in baseband or as part of a carrier wave. Such a propagated signal may take any of a variety of forms including, but not limited to, electro-magnetic, optical, or any suitable combination thereof. A computer-readable signal medium may be any computer-readable medium that is not a computer-readable storage medium and that can communicate, propagate, or transport a program for use by, or in connection with, an instruction execution system, apparatus, or device.

Program code embodied on a computer-readable medium may be transmitted using any appropriate medium including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions, which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus, or other devices, to produce a computer-implemented process such that the instructions which execute on the computer or other programmable apparatus provide processes for implementing the functions/acts specified in the flowchart and/or block diagram block or blocks.

Embodiments of the present invention will now be described in detail with reference to the accompanying Figures.

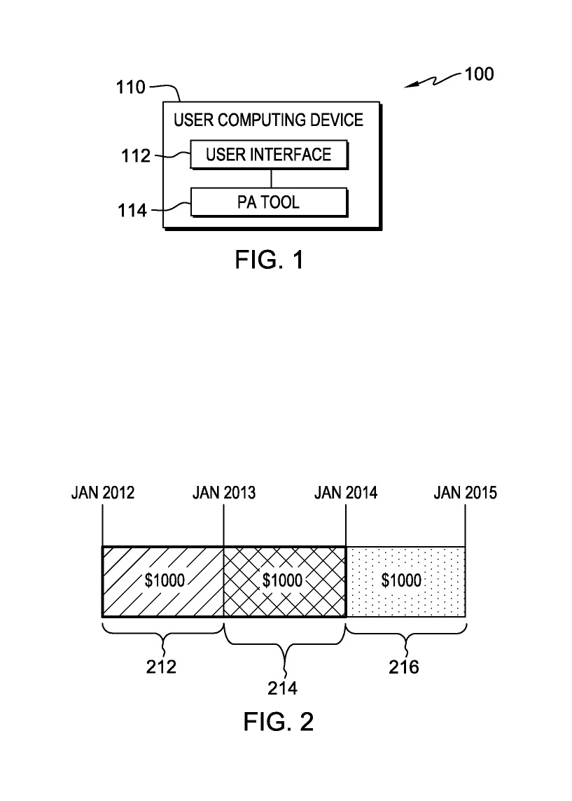

FIG. 1 illustrates projective revenue system 100, in accordance with an embodiment of the invention. In an exemplary embodiment, projective revenue system 100 includes user computing device 110.

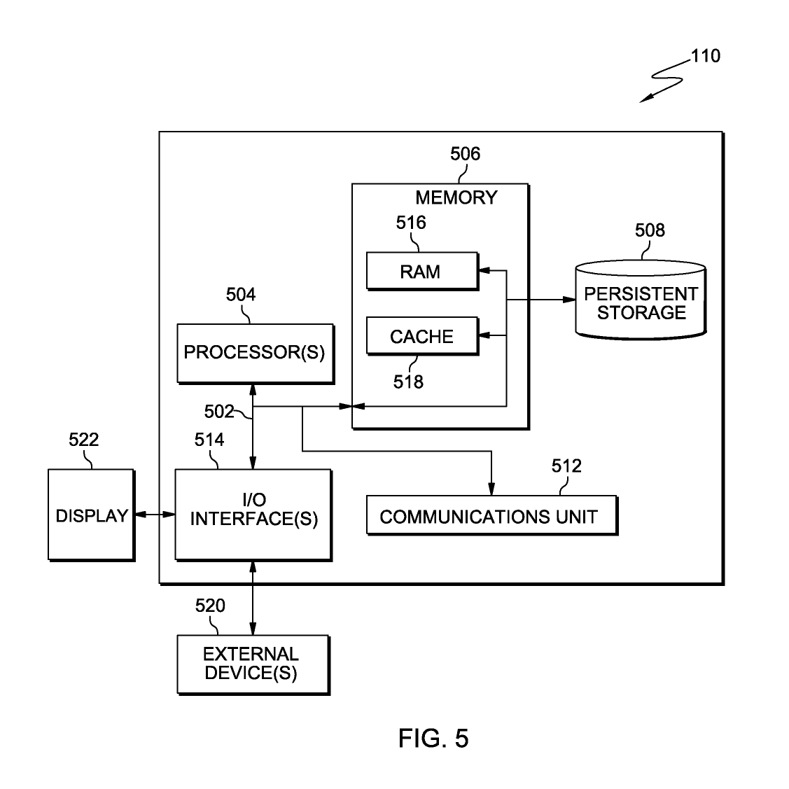

In the exemplary embodiment, user computing device 110 may be a laptop computer, tablet computer, notebook computer, personal computer (PC), a desktop computer, a personal digital assistant (PDA), a smart phone, or any programmable electronic device. In the exemplary embodiment, user computing device 110 includes user interface 112 and PA tool 114. User computing device 110 may include internal and external hardware components, as depicted and described in further detail with respect to FIG. 5.

In the exemplary embodiment, user interface 112 includes components used to receive input from a user of user computing device 110 and transmit the input to PA tool 114. User interface 112 uses a combination of technologies, such as device drivers, to provide a platform to enable users to interact with PA tool 114. In the exemplary embodiment, user interface 112 receives input, such as textual input received from a physical input device such as a keyboard, via a device driver that corresponds to the physical input device.

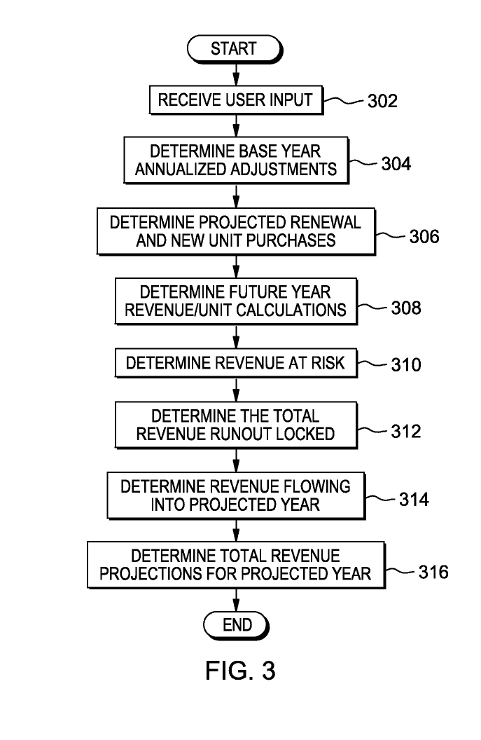

In the exemplary embodiment, PA tool program 114 is software capable of receiving data, such as information regarding the warranty status of units via a network or user input and calculating the projected revenue for any given area of a maintenance organization, such as a technical service and support division, based on input from user computing device 110 via user interface 112. PA tool is discussed in further detail with regard to FIG. 3.

FIG. 2 illustrates the breakdown of potential revenue that may be generated from a contract, in accordance with an embodiment of the invention. In the exemplary embodiment, the illustration depicts a contract, generating $1000/year in revenue, signed Jan. 1, 2012 with an expiration date of Dec. 31, 2013. Locked in revenue 212 depicts the time period in which the revenue from the contract is considered “locked in”. The revenue is considered “locked in” for this time period (Jan. 1, 2012 to Dec. 31, 2012), because the expiration date of the contract is in a subsequent year. At risk revenue 214 depicts the time period in which the revenue from the contract is considered “at risk”. The revenue is considered “at risk” for this time period (Jan. 1, 2013 to Dec. 31, 2013), because the contract is set to expire in this time period, i.e., Dec. 31, 2013. Renewal opportunity 216 depicts the time period in which the revenue from this contract is up for renewal, i.e., the contract has already expired. Therefore, no more revenue will generated from this contract unless it is renewed.

In addition, if the contract, generating $1000/year in revenue, was signed in Jul. 1, 2012 with an expiration date of Jun. 30, 2014, the revenue from the contract is considered “locked in” for the time period starting Jan. 1, 2013 to Dec. 31, 2013 because the contract is up for expiration in the subsequent year. The revenue from the contract is considered “at risk” for the time period starting Jan. 1, 2014 to Jun. 30, 2014 because the contract is set to expire in this time period, i.e., Jun. 30, 2013. Revenue from the contract is considered a “renewal opportunity” from Jul. 1, 2014 to Dec. 31, 2014 because the contract is already expired during this time period and no more revenue will be generated from this contract unless the contract is renewed. In one embodiment, PA tool 114 may cause the breakdown of potential revenue to be displayed to the user via a display device, e.g. display 522. In another embodiment, PA tool 114 may cause a plurality of breakdowns of potential revenue, each breakdown corresponding to one contract, to be displayed to the user via the display device, e.g. display 522, where the plurality of breakdowns of potential revenue are arranged in a manner to allow the user to compare each breakdown of potential revenue against another.

FIG. 3 is a flowchart illustrating the operational steps of projected revenue system 100 in calculating the projected maintenance revenue through the use of inputted inventory baseline, backlog and transaction rates, in accordance with an embodiment of the invention. In general, revenue can be derived from two sources, from warranty upgrades for machines or units sold, which typically only include a basic default warranty and from maintenance contracts/renewals. For example, when a new unit is purchased the customer has the option to upgrade the default warranty. The upgraded warranty has a life span equal to the life span of default warranty, which typically ranges from one to four years. Once the upgraded or default warranty expires, the customer then has the option to continue coverage by way of a maintenance contract, which also has a life span that may be renewed if the customer so desires. Therefore, maintenance revenue is derived from warranty upgrades (referred to as WOU revenue) and from initial (first time) maintenance contract purchases (referred to as HWMA revenue) and maintenance contract renewals (referred to as renewal revenue). In addition, the term “WOU unit” as used in subsequent discussion represents a warranty option upgrade (WOU unit), also referred to as a warranty upgrade, and the term “HWMA unit” represents a maintenance contract. In addition, the term “unit” refers to a machine, or product which may or may not have a default warranty, an upgraded warranty (WOU unit), or a maintenance contract (HWMA unit) associated with it. Also, the term “BLOG” is equivalent to backlog. The process of determining TSS revenue for future years is described in further detail below:

Projective analysis (PA) tool 114 receives user input from a user of user computing device 110 via user interface 112 (step 302). In the exemplary embodiment, required user input includes attrition rate, renewal rate of expired opportunities, warranty capture rate, warranty option upgrade (WOU) attach rates, signing skews, attrition skew, new off warranty units for future years, equivalent expiry renewal units, equivalent WOU units, equivalent HWMA (hardware maintenance) units, new shipments units for future years, average revenue/new units in USD millions, average WOU revenue/new WOU units in USD millions, Base_Year backlog runout locked in USD millions, Base_Year revenue at risk, Base_Year $ foregone in future years if not renewed, average annual revenue/unit in USD millions, and average annual WOU revenue/unit in USD millions. Optionally, user input may also include a general price action (GPA), GPA skew, discount, discount skew, Base_Year units expiring in future years, Base_Year total backlog, existing HWMA units up till Base_Year, and existing WOU units up till Base_Year. In addition, in the exemplary embodiment, the user input includes information for the entire base year if the projections will be conducted on a yearly basis, or for the entire base time period if the projections will be conducted in increments of a different time period (i.e., quarterly, semi-annually, etc.). In the exemplary embodiment, if year 0 is the base year, year 1 begins on the first day of the next year (likewise, time period 1 begins the day after time period 0 ends).

PA tool 114 then determines the Base_Year annualized adjustments (step 304). In the exemplary embodiment, the calculation of the Base_Year annualized adjustments is broken down into 5 equations: Base_Year GPA included locked revenue, adjusted Base_Year $ foregone if not renewed, risk contract TCV (total contract value), adjusted Base_Year backlog at risk and Base_Year adjusted renewal units. In the exemplary embodiment, Base_Year refers to year 0 or the current year. When historical backlog is mentioned, it refers to user input that contains data collected from previous years. Utilizing the received user input, PA tool 114 determines the Base_Year GPA included locked revenue, which is the historical locked backlog that takes future general price action, as well as any applicable discounts into account for each projected year (year 1, 2, 3, etc.). The calculation for year 1 and year 2 is shown below:

Base_Year GPA Included Locked Revenue for Year1=(Base_Year Backlog Runout Locked in USD Millions for Year1)*(1+GPA % for Year1−Discount % for Year1)

The Base_Year backlog runout locked in USD is the amount of revenue that is locked in for the projected year, i.e., year 1. In other words, if a contract, such as a warranty or maintenance contract, has a total worth of $1000 and expires in year 2, the Base_Year backlog runout locked is $1000. However, if the warranty or maintenance contract expires at any time in year 1, there is no locked revenue; rather the revenue from the contract is considered at risk. The Base_Year backlog runout locked for year 1 is then adjusted for general price action and any applicable discounts to get the Base_Year GPA included locked revenue for year 1, as shown above.

The calculation for year 2 is shown below:

Base_Year GPA Included Locked Revenue for Year2=(Base_Year Backlog Runout Locked in USD Millions for Year2)*(1+GPA % for Year1−Discount % for Year1)*(1+GPA % for Year2−Discount % for Year2)

In the exemplary embodiment, the Base_Year GPA included locked revenue for year 2 is calculated in the same manner as year 1; however, the general price action and any applicable discounts for year 1 and year 2 are taken into account. Year3 and year 4 can be calculated in a similar manner, with the price action and discounts for year 3 and year 4 taken into account, respectively.

PA tool 114 then determines the risk contract year TCV (total contract value) for the projected year, which in the exemplary embodiment is year 1 and year 2. The risk contract TCV represents the total revenue that can be realized from units which are currently on contract (warranty or maintenance contract), where the contracts are up for expiration in the projected year, along with expiring warranty maintenance contracts in the projected year. For year 1, the risk contract year TCV is as described below:

Risk Contract Year TCV Total for Year1=((Base_Year Revenue at Risk for Year1)+(Base_Year $ Foregone in Future Years if not Renewed for Year1))*(1+GPA % for Year1−Discount % for Year1)

In the exemplary embodiment, Base_Year revenue at risk represents the revenue “at risk” due to maintenance contracts expiring in the projected year (i.e., year 1 for this case). For example, if a maintenance contract, bringing in $1000 of revenue per year, is set to expire in the middle of year 1, the revenue at risk for the contract is $500. In other words, the revenue is “at risk” because the contract will expire in the projected year and will bring in revenue of $500 dollars before it expires. The Base_Year $ foregone in future years if not renewed for year 1 in this example would also be $500, because if the “at risk” contract is not renewed, the total amount of money foregone in year 1 would be $500. Adjustments for general price action and any applicable discounts are then applied, as shown above to determine the risk contract year TCV for year 1.

Risk Contract Year TCV Total for Year2=((Base_Year Revenue at Risk for Year2)+(Base_Year $ Foregone in Future Years if not Renewed for Year2))*(1+GPA % for Year1−Discount % for Year1)*(1+GPA % for Year2−Discount % for Year2)

The calculation of risk contract year TCV for year 2 is similar to the calculation for year 1, except the general price action and any applicable discounts for year 2 are also taken into account as shown above. The same methodology can be applied to calculate the risk contract year TCV for subsequent years.

PA tool 114 then determines the adjusted Base_Year backlog revenue at risk for year 1 and year 2, which is the Base_Year revenue at risk for the projected year, adjusted for general price action. The calculations are described below:

Adjusted Base_Year Backlog Revenue at Risk in USD Millions for Year1=(Risk Contract Year TCV Total for Year1)−(Adjusted Base_Year $ Foregone if not renewed for Year1)

Adjusted Base_Year Backlog Revenue at Risk in USD Millions for Year2=(Risk Contract Year TCV Total for Year2)−(Adjusted Base_Year $ Foregone if not renewed for Year2)

The adjusted Base_Year backlog revenue at risk for subsequent years (such as year 3 and year 4) may be determined in a similar manner as shown above.

PA tool 114 then determines the adjusted Base_Year $ foregone if not renewed, for year 1 and year 2, which is the Base_Year $ foregone if not renewed for the projected year, adjusted for general price action. The calculations are described below:

Adjusted Base_Year $ Foregone if not renewed for Year1=(Signing Skew % for Year1)*(Risk Contract Year TCV Total for Year1)

Adjusted Base_Year $ Foregone if not renewed for Year2=(Signing Skew % for Year2)*(Risk Contract Year TCV Total for Year2)

In the exemplary embodiment, the signing skew % for all projected years is equal to the signing skew % for the Base_Year. In general, the signing skew % for the Base_Year represents the percent of a time period during which revenue is actually realized after renewal of a contract. For example, if a contract is signed on August 31^{st} of a particular year, the signing skew % is 33.33%, representing the time period (4 months/1 year=⅓) in which revenue is actually earned for the year post renewal. The signing skew % is then multiplied by the risk contract TCV to determine the amount of money foregone if the contract(s) are not renewed in the given year. For example, the signing skew % for year 2 is multiplied by the risk contract TCV for year 2 to determine the amount of money from contracts signed in the Base_Year and expiring in year 2, which would be foregone if the contract is not renewed. Once again, the adjusted Base_Year $ foregone if not renewed for subsequent years (such as year 3 and year 4) may be determined in a similar manner as shown above.

PA tool 114 then determines the Base_Year equivalent adjusted renewal units for year 1 and year 2, which represents the number of units with one or more contracts (such as the number of units on a maintenance contract) which will be expiring in the projected year. This calculation for year 1 and year 2 are shown below:

Base_Year Equivalent Renewal Units for Year1=((Adjusted Base_Year Backlog Revenue at Risk for Year1)+(Adjusted Base_Year $ Foregone if not renewed for Year1))/(Average Annual Rev/Unit-Base_Year in Year1)

Base_Year Equivalent Renewal Units for Year2=((Adjusted Base_Year Backlog Revenue at Risk for Year2)+(Adjusted Base_Year $ Foregone if not renewed for Year2))/(Average Annual Rev/Unit-Base_Year in Year2)

As shown above, the Base_Year equivalent adjusted renewal units for a projected year is calculated by dividing the total amount of revenue which can be realized from units on maintenance contracts expiring in the projected year (at risk revenue plus $ foregone if not renewed) by the average annual revenue per unit. In the exemplary embodiment, the average annual revenue per unit for the base year is used to estimate the average annual revenue per unit for subsequent years.

PA tool 114 then determines projected renewal and new unit signings for the projected years, i.e., year 1 and year 2 (step 306). In the exemplary embodiment, determining projected renewal and new unit signings includes three determinations: equivalent expiry renewal units, total equivalent WOU units, and total equivalent HWMA units.

In the exemplary embodiment, the equivalent expiry renewal units are the number of units with maintenance contracts which will expire in the projected year. The calculation for year 1 and year 2 is described below:

Equivalent Expiry Renewal Units in Year1 coming from Base_Year=(Base_Year Equivalent Renewal Units Calculated come out to be for Year1)*(Renewal Rate of Expired Opportunities % of Year1)*(1−Attrition Rate % for Year1)

Equivalent Expiry Renewal Units in Year2 coming from Base_Year=(Base_Year Equivalent Renewal Units Calculated come out to be for Year2)*(1−Attrition Rate % for Year1)+(Equivalent Expiry Renewal Units in Year1 coming from Base_Year*Equivalent Expiry Renewal % in Year2 coming from Year1))*(Renewal Rate of Expired Opportunities for Year2)*(1−Attrition Rate % for Year2)

Equivalent Expiry Renewal Units in Year2 coming from Year1 New Units=(Total Equivalent HWMA Units for Year1)*(Year1 Equivalent HWMA Units % for Year2)*(Renewal Rate of Expired Opportunities % for Year2)*(1−Attrition Rate % for Year2)

As shown above, the equivalent expiry renewal units for a projected year takes into account maintenance contracts signed in the base year and subsequent years up to the projected year. For example, the equivalent expiry renewal units for year 2 takes into account maintenance contracts expiring in year 2 which were signed/renewed in the base year and also maintenance contracts expiring in year 2 which were signed/renewed in year 1. In the exemplary embodiment, an attrition rate, which is the percentage of revenue expected to be lost from non-expiring contracts in the projected year (from rolls, early termination, etc.), for year 1 and year 2 are also taken into account. In addition, subsequent years may be projected in a similar manner as described for year 2, with new contracts signed in the base year and subsequent years up to the projected year.

In the exemplary embodiment, the total equivalent WOU units and HWMA units for the projected year are calculated as described below:

Total Equivalent WOU Units for Year1=(New Shipments Units For Future Years of Year1)*(WOU Attach Rates % for Year1)

Total Equivalent HWMA Units for Year1=(New OFF Warranty Units for Future Years of Year1)*(Warranty Capture Rate % for Year1)

Total Equivalent WOU units for Year2=(New Shipments Units For Future Years of Year2)*(WOU Attach Rates % for Year2)

Total Equivalent HWMA Units for Year2=(New OFF Warranty Units for Future Years for Year2)*(Warranty Capture Rate % for Year2)

As shown above, the total equivalent WOU units for the projected year is equal to the number of new units projected to be sold in the projected year multiplied by a WOU attach rate %, which is the estimated percentage of new units which will include an upgraded warranty. The total equivalent HWMA units for the projected year is equal to the number of units which have warranties (default warranties or upgraded warranties) which will expire in the projected year multiplied by the estimated percentage of new units coming off warranty which are projected to sign a maintenance contract (i.e., the warranty capture rate). Once again, calculations for subsequent years may be calculated in a similar manner as described above.

PA tool 114 then determines the future year revenue/unit calculations (step 308). In the exemplary embodiment, future year revenue/unit calculations for year 1 and year 2 are broken down into HWMA average annual revenue/unit and WOU average annual revenue/unit. The calculations for HWMA average annual revenue/unit for year 1 are as described below:

Average Annual Rev/Unit-Base_Year in Year1=Average Annual Revenue/Unit in USD Millions for Base_Year*(1+GPA % for Year1−Discount % for Year1)

Average Annual Rev/Unit-Year1 in Year1=Average Annual Revenue/Unit in USD Millions for Year1*(1+GPA % for Year1−Discount % for Year1)

As shown above, the average annual revenue/unit for base year and the average annual revenue/unit for year 1 are adjusted for general price action and any applicable discounts to determine the average annual rev/unit-base year in year 1 and average annual rev/unit-year 1 in year 1, respectively. The calculations for average annual revenue/unit for year 2 are as described below:

Average Annual Rev/Unit-Base_Year in Year2=Average Annual Revenue/Unit in USD Millions for Base_Year in Year1*(1+GPA % for Year2−Discount % for Year2)

Average Annual Rev/Unit-Year1 in Year2=Average Annual Revenue/Unit in USD Millions−Year 1 for Year1*(1+GPA % for Year2−Discount % for Year2)

Average Annual Rev/Unit-Year2 in Year2=Average Annual Revenue/Unit in USD Millions for Year2*(1+GPA % for Year2−Discount % for Year2)

The calculations for WOU average annual revenue/unit are for year 1 as described below:

Average Annual WOU Rev/Unit-Base_Year in Year1=Average Annual WOU Revenue/Unit in USD Millions for Base_Year*(1+GPA % for Year1−Discount % for Year1)

Average Annual WOU Rev/Unit-Year1in Year1=Average Annual WOU Revenue/Unit in USD Millions for Year1*(1+GPA % for Year1−Discount % for Year1)

As shown above, PA tool 114 first determines the average annual WOU revenue/unit for the base year from warranty upgrades coming forward from the base year and adjusted for general price action and applicable discounts. PA tool 114 then determines the average annual WOU revenue/unit for year 1 that may be potentially realized from warranty upgrades for new units signed in year 1, again adjusting for general price action and applicable discounts.

The WOU average annual revenue/unit calculations for year 2 are broken down as described below. In addition, subsequent years may be calculated in a similar manner as shown for year 2.

Average Annual WOU Rev/Unit-Base_Year in Year2=Average Annual WOU Revenue/Unit in USD Millions Base in Year1*(1+GPA % for Year2−Discount % for Year2)

Average Annual WOU Rev/Unit-Year1in Year2=Average Annual WOU Revenue/Unit in USD Millions−Year 1 for Year1*(1+GPA % for Year2−Discount % for Year2)

Average Annual WOU Rev/Unit-Year2 in Year2=Average Annual WOU Revenue/Unit in USD Millions for Year2*(1+GPA % for Year2−Discount % for Year2)

PA tool 114 then determines the revenue at risk for the projected years, year 1 and year 2 (step 310). In the exemplary embodiment, the total revenue at risk includes calculating the renewal revenue at risk, and the HWMA revenue at risk. The renewal revenue at risk for a projected year represents the revenue at risk from units with on maintenance contracts (that are not initial or first-time maintenance contracts), which are up for expiration in the projected year and therefore, up for renewal in the form of a maintenance contract. The HWMA revenue at risk for a projected year represents the revenue at risk from units, projected to be installed in a year subsequent to the base year, with an initial or first-time maintenance contract that is up for expiration in the projected year and therefore, up for renewal for the first time in the form of a maintenance contract. The equation for the revenue at risk for year 1 is shown below.

Renewal Revenue at Risk in Year1 coming from Year1=Equivalent Expiry Renewal Units in Year1 coming from Base_Year*(1−sum(Equivalent Expiry Renewal Units % in Year1 coming from Year2,Year 3,Year 4,Year 5))*Average Annual Rev/Unit-Base_Year in Year1*(1−Signing Skew % for Year1)

Renewal revenue expiry at risk in Year 1 coming from Year 1 is the renewal revenue at risk from non-initial maintenance contracts expiring in year 1. The equivalent expiry renewal units in year 1 coming from base year represents the number of renewal units, such as non-initial maintenance contracts, which were signed in the base year and are expiring in year 1, while the equivalent expiry renewal units % represent the percentage of renewal units expiring in subsequent years. For example, in this case, the equivalent expiry renewal units % represents the percentage of renewal units expiring in year 2, year 3, year 4, and year 5.

HWMA Revenue at Risk in Year1 coming from Year1=Total Equivalent HWMA Units in Year1*((Sum(Equivalent HWMA % in Year1 coming from Year2,Year3,Year4,Year5))−(Sum(Equivalent HWMA % in Year1 coming from Year2,Year3,Year4,Year5))*Average Annual Rev/Unit-Year1in Year1*(1−Signing Skew % for Year1)

The HWMA revenue at risk in year 1 coming from year 1 is the revenue at risk from initial maintenance contracts expiring in year 1. In addition, the equivalent HWMA % represents the percentage of initial maintenance contracts expiring in subsequent years. For example, in this case, the equivalent HWMA % represents the percentage of initial maintenance contracts expiring in year 2, year 3, year 4, and year 5. The total revenue at risk in year 1 coming from year 1 is described below:

Total Revenue at Risk in Year1 coming from Year1=Renewal Revenue at Risk in Year1 coming from Year1+HWMA Revenue at Risk in Year1 coming from Year1

The total revenue at risk in year 2 coming from year 1 is calculated in a similar manner, and is described below:

Renewal Revenue at Risk in Year2 coming from Year1=Equivalent Expiry Renewal Units in Year1 coming from Base_Year*Equivalent Expiry Renewal % in Year1 coming from Year2*Average Annual Rev/Unit-Base_Year in Year2*(1−Signing Skew % for Year1)*(1−Attrition Rate % for Year2)

HWMA Expiry Revenue at Risk in Year2 coming from Year1=Total Equivalent HWMA Units of Year1*Equivalent HWMA Units % in Year1 coming from Year2*Average Annual Rev/Unit-Year1in Year2*(1−Signing Skew % for Year1)*(1−Attrition Rate % for Year2)

Total Revenue at Risk in Year2 coming from Year1=Renewal Revenue at Risk in Year2 coming from Year1+HWMA Expiry Revenue at Risk in Year2 coming from Year1

In general, the total revenue at risk in year X coming from year 1, with year X representing year 3, year 4, year 5, etc, can be calculated in a similar manner as described for the total revenue at risk in year 2 coming from year 1.

The equations for the revenue at risk for year 2 are shown below:

Renewal Revenue at Risk in Year2 coming from Year2=Equivalent Expiry Renewal Units in Year2 coming from Base_Year*(1−Sum(Equivalent Expiry Renewal % in Year2 coming from Year3,Year4,Year5,Year6))*Average Annual Rev/Unit-Base_Year in Year2*(1−Signing Skew % for Year2)+Equivalent Expiry Renewal Units in Year2 coming from Year1 New Units*(1−Sum(Equivalent Expiry Renewal % in Year2 coming from Year3,Year4,Year5,Year6))*Average Annual Rev/Unit-Year1in Year2*(1−Signing Skew % for Year2)

HWMA Expiry Revenue at Risk in Year2 coming from Year2=Total Equivalent HWMA Units of Year2*((1−Sum(Equivalent HWMA % in Year2 coming from Year3,Year4,Year5,Year6))*Average Annual Rev/Unit-Year2 in Year2*Signing Skew % for Year2

Total Revenue at Risk in Year2 coming from Year2=(Renewal Expiry Revenue at Risk in Year2 coming from Year2)+(HWMA Expiry Revenue at Risk in Year2 coming from Year2)

Renewal Expiry Revenue at Risk in Year3 coming from Year2=((Equivalent Expiry Renewal Units in Year2 coming from Base_Year)*Equivalent Expiry Renewal Units % in Year2 coming from Year3*Average Annual Rev/Unit-Base_Year in Year3*(1−Signing Skew % for Year2)+Equivalent Expiry Renewal Units in Year2 coming from Year1New Units*Equivalent Expiry Renewal Units % in Year2 coming from Year3*Average Annual Rev/Unit-Year1 in Year3*(1−Signing Skew % for Year2)*(1−Attrition Rate % for Year3)

HWMA Expiry Revenue at Risk in Year3 coming from Year2=Total Equivalent HWMA Units for Year2*Equivalent HWMA Units % in Year2 coming from Year3*Average Annual Rev/Unit-Year2 in Year3*(1−Signing Skew % for Year2)*(1−Attrition Rate % for Year3)

Total Revenue at Risk in Year3 coming from Year2=Renewal Expiry Revenue at Risk in Year3 coming from Year2+HWMA Expiry Revenue at Risk in Year3 coming from Year2

Once again, the total revenue at risk in year X coming from year 2, with year X representing year 4, year 5, etc., can be calculated in a similar manner as described for the total revenue at risk in year 3 coming from year 2. In addition, the revenue at risk for subsequent years such as year 3, year 4, year 5, etc., are calculated in a similar way as described in the discussion of the revenue at risk for year 2.

PA tool 114 then determines the total revenue runout locked for the projected years (step 312), which represents revenue associated with contracts (WOU, HWMA) that are “locked in” for the projected year and, therefore, expire in a subsequent year. In the exemplary embodiment, the revenue runout locked includes renewal runout locked, WOU runout locked, and HWMA runout locked. The renewal runout locked represents the revenue generated from renewed maintenance contracts expiring in a subsequent year. The WOU runout locked represents the revenue generated from warranty upgrades in the projected year. For example, for a warranty upgrade that brings in $1000/year in revenue and was signed in the base year and expires in year 2, the WOU runout locked for year 1 is $1000. The HWMA runout locked represents the revenue generated from new/initial maintenance contracts purchased after warranty expiration (such as default warranty expiration), with the new/initial maintenance contract expiring in a subsequent year. The calculations for year 1 is shown below:

Renewal Run out Locked in Year1 coming from Year1=Equivalent Expiry Renewal Units in Year1 coming from Base_Year*(1−0)*Average Annual Rev/Unit-Base_Year in Year1*Signing Skew % for Year1

WOU Run out Locked in Year1 coming from Year1=Total Equivalent WOU Units in Year1*((sum(Equivalent WOU Units % in Year1 coming from Year2,Year3,Year4,Year5)−0)*Average Annual WOU Rev/Unit-Year1 in Year1*Signing Skew % for Year1*(Equivalent WOU Units % in Year1 coming from Year2+(Equivalent WOU Units % in Year1 Coming from Year3/2)+(Equivalent WOU Units % in Year1 coming from Year4/3)+(Equivalent WOU Units % in Year1 coming from Year5/4))

HWMA Run out Locked in Year1 coming from Year1=Total Equivalent HWMA Units for Year1*(1−0)*Average Annual Rev/Unit-Year1 in Year1*Signing Skew % for Year1

Total Run out Locked value in Year1 coming from Year1=Renewal Run out Locked in Year1 coming from Year1+WOU Run out Locked in Year1 coming from Year1+HWMA Run out Locked in Year1 coming from Year1

Renewal Run out Locked in Year2 coming from Year1=Equivalent Expiry Renewal Units in Year1 coming from Base_Year*(1−Sum(Equivalent Expiry Renewal % in Year1 coming from Year2))*Average Annual Rev/Unit-Base_Year in Year2*(1−Attrition Rate % for Year2)

WOU Runout Locked in Year2 coming from Year1=Total Equivalent WOU Units in Year1*(Sum(Equivalent WOU % in Year1 coming from Year2,Year3,Year4,Year5))*Average Annual WOU Rev/Unit-Year1in Year2*(Equivalent WOU Units % in Year1 coming from Year2*(1−Signing Skew % for Year1)+(Equivalent WOU Units % in Year1 coming from Year3/2)+(Equivalent WOU Units % in Year1 coming from Year4/3)+(Equivalent WOU Units % in Year1 coming from Year5/4)

HWMA Run out Locked in Year2 coming from Year1=Total Units of Equivalent HWMA in Year1*(1−Sum(Equivalent HWMA Units % in Year1 coming from Year2))*Average Annual Rev/Unit-Year1in Year1*(1−Attrition Rate % for Year2)

Total Run out Locked value in Year2 coming from Year1=Renewal Run out Locked in Year2 coming from Year1+WOU Runout Locked in Year2 coming from Year1+HWMA Run out Locked in Year2 coming from Year1

In the exemplary embodiment, the equivalent expiry renewal units represents the units on non-initial maintenance contracts which are expiring in the projected year. For example, the Equivalent Expiry Renewal Units in Year1 coming from Base_Year represents the units with non-initial maintenance contracts which were signed in the base year and are expiring in year 1. The equivalent expiry renewal units % represents the percentage of renewal units (units with non-initial maintenance contracts) that are up for expiration in the given year. For example, the Equivalent Expiry Renewal Units % in Year2 coming from Year3 represents the percentage of renewal units (units with non-initial maintenance contracts) which were signed in year 2 and are up for expiration in year 3. The total equivalent WOU units represent the number of units with warranty upgrades. The equivalent WOU units % represents the percentage of units with upgraded warranties that are up for expiration in the given year. In addition, as shown above, when calculating the WOU revenue locked, the equivalent WOU unit % is divided by a number equal to the difference between the projected year and the “coming from” year. For example, “Equivalent WOU Units % in Year1 coming from Year4/3” represents the percentage of warranty upgrade units signed in year 1 that are still un-expired prior to year 4. The revenue generated from the warranty upgrade is evenly spread between the years, which is why the equivalent WOU units % in year 1 coming from year 4 is divided by 3.

The total equivalent HWMA units represent the number of units with initial (first-time) maintenance contracts. The equivalent HWMA units % represents the percentage of units with initial (first-time) maintenance contracts that are up for expiration in the given year (projected year).

In general, the same methodology as shown above can be utilized in order to determine the total run out locked value in year X coming from year 1. The calculation of the total run out locked for year 2 is shown below:

Renewal Run out Locked in Year2 coming from Year2=(Base_Year Total Equivalent Expiry Renewal Units*(1−0)*Average Annual Rev/Unit-Base_Year in Year 2*Signing Skew % in Year 2)+(Year1Equivalent Expiry Renewal Units*(1−0)*Average Annual Rev/Unit-Year1 in Year2*Signing Skew % in Year 2)

WOU Run out Locked in Year2 coming from Year2=Total Equivalent WOU Units in Year2*((sum(Equivalent WOU Units % in Year2 coming from Year3,Year4,Year5,Year6)−0)*Average Annual WOU Rev/Unit-Year2 in Year2*Signing Skew % in Year2*(Equivalent WOU Units % in Year2 coming from Year3+(Equivalent WOU Units % in Year2 coming from Year4/2)+(Equivalent WOU Units % in Year2 coming from Year5/3)+(Equivalent WOU Units % in Year2 coming from Year6/4))

HWMA Run out Locked in Year2 coming from Year2=Total Equivalent HWMA Units in Year2*(1−0)*Average Annual Rev/Unit-Year2 in Year2*Signing Skew % in Year2

Total Run out Locked value in Year2 coming from Year2=Renewal Run out Locked in Year2 coming from Year2+WOU Run out Locked in Year2 coming from Year2+HWMA Run out Locked in Year2 coming from Year2

Renewal Run out Locked in Year3 coming from Year2=((Equivalent Expiry Renewal Units in Year2 coming from Base_Year)*1−sum(Equivalent Expiry Renewal Units % in Year2 coming from Year3))*Average Annual Rev/Unit-Base_Year in Year3+Equivalent Expiry Renewal Units in Year2 coming from Year1New Units*(1−sum(Equivalent Expiry Renewal Units % in Year2 coming from Year3))*Average Annual Rev/Unit-Year1in Year3)*((1−Attrition Rate % for Year3)

WOU Run out Locked in Year3 coming from Year2=Total Units of Equivalent WOU in Year2*((sum(Equivalent WOU Units % in Year2 coming from Year3,Year4,Year5,Year6))*Average Annual WOU Rev/Unit-Year2 in Year3*(Equivalent WOU Units in Year2 coming from Year3*(1−Signing Skew % in Year2)+Equivalent WOU Units % in Year2 coming from Year4/2+Equivalent WOU Units % in Year2 coming from Year5/3+Equivalent WOU Units % in Year2 coming from Year6/4)

HWMA Run out Locked in Year3 coming from Year2=Total Units of Equivalent HWMA in Year2*(1−Sum(Equivalent HWMA Units % in Year2 coming from Year3))*Average Annual Rev/Unit-Year2 in Year3*(1−Attrition Rate % for Year3)

Total Run out Locked value in Year3 coming from Year2=Renewal Run out Locked in Year3 coming from Year2+WOU Run out Locked in Year3 coming from Year2+HWMA Run out Locked in Year3 coming from Year2

Once again, the same methodology can be utilized in order to determine the total run out locked value in year x coming from year 2.

PA tool 114 then determines the revenue flowing into the projected year (step 314). In the exemplary embodiment, determining the revenue flowing into the projected year, i.e., year 1 and year 2, includes calculating the backlog locked revenue, the backlog revenue at risk, $ foregone in the projected year if not renewed, the expected renewals revenue, the renewal opportunity loss in the projected year due to attrition, attrition loss, the total possible attrition loss, the revenue earned before attrition actually happens, the expected backlog revenue, the average WOU revenue/unit in year 1 coming from Base_Year, and the average annual revenue/unit in year 1 coming from Base_Year. The calculations for the revenue flowing into year 1 from the Base_Year are shown below:

Backlog Locked Revenue in Year1 coming from Base_Year=(Base_Year GPA Included Locked Revenue coming from Year1)*(1−Attrition Rate % in Year1)

Backlog Revenue at Risk in Year1 coming from Base_Year=(Adjusted Base_Year Backlog Revenue at Risk in USD millions coming from Year1)*(1−Attrition Rate % in Year1)

$ Foregone value in Year1if not Renewed coming from Base_Year=Adjusted Base_Year $ Foregone if not renewed coming from Year1*(1−Attrition Rate % in Year1)

Expected Renewals Revenue in Year1 coming from Base_Year=Renewal Rate of Expired Opportunities coming from Year1*$ Foregone value in Year1if not Renewed coming from Base_Year

Renewal Opportunity Loss in Year1 due to Attrition coming from Base_Year=−Expected Renewals Revenue in Year1 coming from Base_Year*Attrition Rate % in Year1/(1−Attrition Rate % in Year1)

Attrition Loss in Year1 coming from Base_Year=−(Base_Year GPA Included Locked Revenue coming from Year1+Adjusted Base_Year Blog Revenue at Risk in USD Millions coming from Year1)*Attrition Rate % in Year1

Total Possible Attrition Loss in Year1 coming from Base_Year=Attrition Loss in Year1 coming from Base_Year+Renewal Opportunity Loss in Year1 due to Attrition coming from Base_Year

Revenue Earned in Year1 coming from Base_Year Before Attrition Actually happens=−(Attrition Loss in Year1 coming from Base_Year)*(1−Attrition Skew % in Year1)

Expected BLOG Revenue in Year1 coming from Base_Year=BLOG locked Revenue in Year1 coming from Year1+Expected Renewals Revenue in Year1 coming from Base_Year+BLOG Revenue at Risk in Year1 coming from Base_Year

Average WOU/Revenue/Unit in Year1 coming from Base_Year=Average Annual WOU Revenue/New Units in USD Millions for Base_Year

Average Annual Revenue/Unit in Year1 coming from Base_Year=Average Annual Revenue/Unit in USD Millions for Base_Year

Based on the calculations for the revenue flowing into year 1 from the Base_Year, PA tool 114 determines the total revenue flowing into year 1 as shown below:

Backlog Locked Revenue in Year1=Backlog Locked Revenue in Year1 coming from Base_Year

BLOG Revenue at Risk in Year1=Backlog Revenue at Risk in Year1 coming from Base_Year

$ Foregone in Year1if not Renewed=$ Foregone value in Year1if not Renewed coming from Base_Year

Expected Renewals Revenue in Year1=Expected Renewals Revenue in Year1 coming from Base_Year

Renewal Opportunity Loss in Year1 due to Attrition=Renewal Opportunity Loss in Year1 due to Attrition coming from Base_Year

Attrition Loss in Year1=Attrition Loss in Year1 coming from Base_Year

Total Possible Attrition Loss in Year1=Total Possible Attrition Loss in Year1 coming from Base_Year

Revenue Earned in Year1Before Attrition Actually happens=Revenue Earned in Year1 coming from Base_Year Before Attrition Actually happens

Expected BLOG Revenue in Year1=Expected BLOG Revenue in Year1 coming from Base_Year

Average WOU/Revenue/Unit in Year1=Average WOU/Revenue/Unit in Year1 coming from Base_Year

Average Annual Revenue/Unit in Year1=Average Annual Revenue/Unit in Year1 coming from Base_Year

In the exemplary embodiment, the revenue flowing into year 2 takes into account both the revenue flowing into year 2 from the Base_Year and also the revenue flowing into year 2 from year 1. The calculations for the revenue flowing into year 2 are shown below:

BLOG Locked Revenue for Base_Year=Base_Year GPA Included Locked Revenue for Year1*(1−Attrition Rate % for Year1)*(1−Attrition Rate % for Year2)

BLOG Revenue at Risk for Base_Year=Adjusted Base_Year Blog Revenue at Risk in USD Millions for Year2*(1−Attrition Rate % for Year1)*(1−Attrition Rate % for Year2)

$ Foregone in Base_Year if not Renewed=Adjusted Base_Year $ Foregone if not renewed for Year2*(1−Attrition Rate % for Year1)*(1−Attrition Rate % for Year2)

Expected Renewals Revenue for Base_Year=Renewal Rate of Expired Opportunities for Year2*$ Foregone in Base_Year if not Renewed

Renewal Opportunity Loss in Base_Year due to Attrition=−Expected Renewals Revenue for Base_Year/((1−Attrition Rate % for Year1)*(1−Attrition Rate % for Year2))*(Attrition Rate % for Year1+(1−Attrition Rate % for Year1)*Attrition Rate % for Year2)

Attrition Loss for Year Base_Year=−(Attrition Rate % for Year1+(1−Attrition Rate % for Year1)*Attrition Rate % for Year2)*(Base_Year GPA Included Locked Revenue for Year2+Adjusted Base_Year Blog Revenue at Risk in USD Millions for Year2)

Total Possible Attrition Loss in Base_Year=Renewal Opportunity Loss in Base_Year due to Attrition+Attrition Loss for Base_Year

Revenue Earned in Base_Year Before Attrition Actually happens=(BLOG Locked Revenue for Base_Year+BLOG Revenue at Risk for Base_Year)*Attrition Rate % for Year2*(1−Attrition Skew % for Year2)/(1−Attrition Rate % for Year2)

Expected BLOG Revenue for Base_Year=BLOG locked Revenue for Base_Year+Expected Renewals Revenue for Base_Year+BLOG Revenue at Risk for Base_Year

BLOG Locked Revenue for Year1=Year1 Total Run out Locked for Year2

BLOG Revenue at Risk for Year1=Year1 Total Revenue at Risk for Year2

$ Foregone in Year1if not Renewed=BLOG Revenue at Risk for Year1*Signing Skew % for Year1/(1−Signing Skew % for Year1)

Expected Renewals Revenue for Year1=Renewal Rate of Expired Opportunities for Year2*$ Foregone in Year1if not Renewed

Renewal Opportunity Loss in Year1 due to Attrition=−Expected Renewals Revenue for Year1/((1−Attrition Rate % for Year1)*(1−Attrition Rate % for Year2))*(Attrition Rate % for Year1+(1−Attrition Rate % for Year1)*Attrition Rate % for Year2)

Attrition Loss for Year1=−((Year1Runout Locked for Year2+Year1 Revenue at Risk for Year2)/((1−Attrition Rate % for Year2)*(1−Attrition Rate % for Year1)))*(Attrition Rate % for Year1+(1−Attrition Rate % for Year1)*Attrition Rate % for Year2)

Total Possible Attrition Loss in Year1=Renewal Opportunity Loss in Year1 due to Attrition+Attrition Loss for Year1

Revenue Earned in Year1Before Attrition Actually happens=(BLOG Locked Revenue for Year1+BLOG Revenue at Risk for Year1)*Attrition Rate % for Year2*(1−Attrition Skew % for Year2)/(1−Attrition Rate % for Year2)

Expected BLOG Revenue for Year1=BLOG locked Revenue for Year1+Expected Renewals Revenue for Year1+BLOG Revenue at Risk for Year1

The calculations for the total revenue flowing into year 2 are shown below, taking into account, the revenue flowing into year 2 from the Base_Year and the revenue flowing into year 2 from year 1.

BLOG Locked Revenue for Year2=BLOG Locked Revenue for Year Base_Year+BLOG Locked Revenue for Year1

BLOG Revenue at Risk for Year2=BLOG Revenue at Risk for Base_Year+BLOG Revenue at Risk for Year1

$ Foregone in Year2 if not Renewed=$ Foregone in Base_Year if not Renewed+$ Foregone in Year1if not Renewed

Expected Renewals Revenue for Year2=Expected Renewals Revenue for Base_Year+Expected Renewals Revenue for Year1

Renewal Opportunity Loss in Year2 due to Attrition=Renewal Opportunity Loss in Base_Year due to Attrition+Renewal Opportunity Loss in Year1 due to Attrition

Attrition Loss for Year2=Attrition Loss for Year Base_Year+Attrition Loss for Year1

Total Possible Attrition Loss in Year2=Total Possible Attrition Loss in Base_Year+Total Possible Attrition Loss in Year1

Revenue Earned in Year2 Before Attrition Actually happens=Revenue Earned in Base_Year Before Attrition Actually happens+Revenue Earned in Year1Before Attrition Actually happens

Expected BLOG Revenue for Year2=Expected BLOG Revenue for Base_Year+Expected BLOG Revenue for Year1

Average WOU/Revenue/Unit for Year2=Average Annual WOU Revenue/New Units in USD Millions for Year2*(1+GPA for Year2)

Average Annual Revenue/Unit for Year2=Average Annual Revenue/New Units in USD Millions for Year2*(1+GPA for Year2)

In the exemplary embodiment, the revenue flowing into subsequent years can be calculated in a similar manner as described for year 2, with the calculations taking into account revenue flowing into the projected year from previous years up to the Base_Year.

PA tool 114 then determines total revenue projections for the projected year (step 316). In the exemplary embodiment, the total revenue projections include calculating the new HWMA revenue, the new WOU revenue, the GPA skew loss, the discount skew loss, the total expected revenue for the projected year from all years, the annualized new HWMA revenue, and the total new HWMA backlog. The calculations for the total revenue projections for year 1 are shown below:

New HWMA Revenue in Year1=Average Annual Rev/Unit-Year1in Year1*Warranty Capture Rate % in Year1*Signing Skew % in Year1*New OFF Warranty Units for Future Years in Year1

New WOU Revenue in Year1=Year1 WOU Run out Locked for Year1

Total Expected Revenue for Year1 from ALL Years=(NEW WOU Revenue for Year1+New HWMA Revenue for Year1+Expected BLOG Revenue for Year1+Revenue Earned in Year1Before Attrition Actually happens)−Year1 GPA Skew Loss+Year1 Discount Skew Loss

Year1GPA Skew Loss=New WOU Revenue in Year1+New HWMA Revenue in Year1+Expected BLOG Revenue in Year1+Revenue Earned in Year1Before Attrition Actually happens*((1−1/(1+GPA % in Year1))*(1−GPA Skew % in Year1)

Year1Discount Skew Loss=New WOU Revenue in Year1+New HWMA Revenue in Year1+Expected BLOG Revenue in Year1+Revenue Earned in Year1Before Attrition Actually happens*(−(1−1/(1−Discount % in Year1))*(1−Discount Skew % in Year1)

Annualized New HWMA Revenue for Year1=New HWMA Revenue for Year1/Signing Skew % for Year1

Total New HWMA BLOG for Year1=Annualized New HWMA Revenue for Year1*Average Contract Length in Years-calculated automatically for Year1−New HWMA Revenue for Year1

The calculations for the total revenue projections for year 2 are shown below:

New HWMA Revenue for Year2=Average Annual Rev/Unit-Year2 for Year2*Signing Skew % for Year2*New OFF Warranty Units for Future Years for Year2*Warranty Capture Rate % for Year2

New WOU Revenue for Year2=Year2 WOU Runout Locked value for Year2

Total Expected Revenue for Year2=New HWMA Revenue for Year2+New WOU Revenue for Year2+Expected BLOG Revenue for Year2+Revenue Earned in Year2 Before Attrition Actually happens−Year2 GPA Skew Loss+Year2 Discount Skew Loss

Year2 GPA Skew Loss=New HWMA Revenue for Year2+New WOU Revenue for Year2+Expected BLOG Revenue for Year2+Revenue Earned in Year2 Before Attrition Actually happens*((1−1/(1+GPA % in Year2))*(1−GPA Skew % in Year2)

Year2 Discount Skew Loss=New HWMA Revenue for Year2+New WOU Revenue for Year2+Expected BLOG Revenue for Year2+Revenue Earned in Year2 Before Attrition Actually happens*(−(1−1/(1−Discount % in Year2))*(1−Discount Skew % in Year2)

Annualized New HWMA Revenue for Year2=New HWMA Revenue for Year2/Signing Skew % for Year2

Total New HWMA BLOG for Year2=Annualized New HWMA Revenue for Year2*Average Contract Length in Years-calculated automatically for Year2−New HWMA Revenue for Year2

In the exemplary embodiment, as shown above, the total expected revenue takes into account new HWMA revenue for the projected year, new WOU revenue for the projected year, expected backlog revenue for the projected year, revenue earned in the projected year before attrition actually happens, general price action, general price action skews, and any applicable discounts and discount skews. In the exemplary embodiment, the general price action skew is taken into account when a price action is announced in the middle of year or time period. For example, if a unit has a maintenance contract which generates $100/year of revenue in the base year, and a general price action of 10% is announced at the beginning of year 1, the general price action is taken into account when determining the revenue for year 1. In other words, the revenue for year 1 is increased by the price action percentage, which in this case would equate to a year 1 revenue from the unit of $110. However, if the general price action of 10% is announced in the middle of the year, then a GPA skew % of 50% would be applied (since only one half of the yearly revenue will be adjusted), which will result in a year 1 revenue from the unit of $105. Similarly, the discount skew % works in the same manner, if a discount of 10% is announced for the unit in the middle of the year (assuming the unit is generating $100/year in revenue), a discount skew % of 50% is then applied to the revenue of the unit resulting in a year 1 revenue of $95.

In addition, the total revenue projections for subsequent years can be determined in a similar manner as described above in the discussion of total revenue projections for year 2.

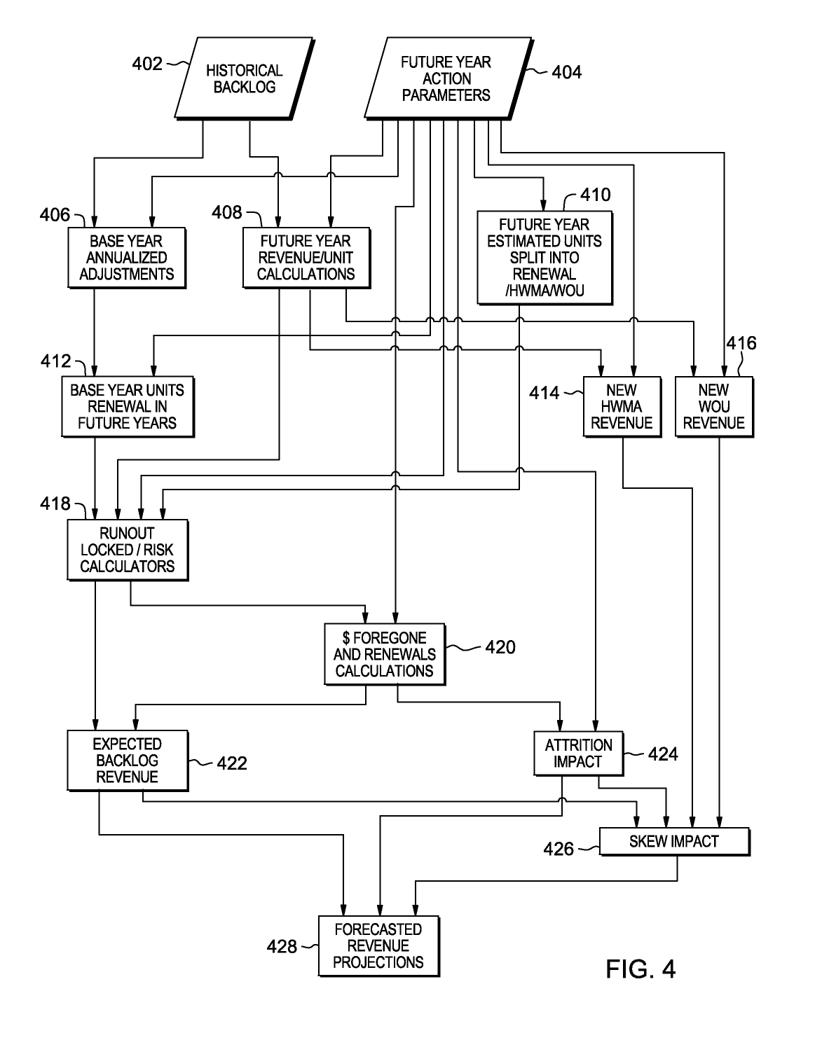

FIG. 4 depicts the overall process flow and interdependencies between the determinations which form the basis of projecting revenue for a given year, in accordance with an embodiment of the invention. In the exemplary embodiment, the overall process flow contains 8 overall steps, with the components of each step shown in parallel to one another, i.e., step 1 includes the components: historical backlog 402 and future year action parameters 404. Overall the components of FIG. 4 include: historical backlog 402, future year action parameters 404, base year annualized adjustments 406, future year revenue/unit calculations 408, future year estimated units split into renewal/HWMA/WOU 410, base year units renewal in future years 412, new HWMA revenue 414, new WOU revenue 416, runout locked/risk calculators 418, $ foregone and renewals calculations 420, expected backlog revenue 422, attrition impact 424, skew impact 426, and forecasted revenue projections 428. The lines pointing to a component represent all the inputs necessary in order to compute that component. For example, to compute the component base year annualized adjustments 406, the necessary inputs are historical backlog 402 and future year action parameters 404.

As depicted, PA tool 114 begins with user input, such as historical backlog 402 and future year action parameters 404. PA tool 114 utilizes this input to determine the components of the second step in the process flow which are base year annualized adjustments 406, future year revenue/unit calculations 408, and future year estimated units split into renewal/HWMA/WOU 410. PA tool 114 then utilizes the necessary inputs to calculate the components of each subsequent step in order to calculate forecasted revenue projections 428, which represents the forecasted revenue projections for a given year or a given time period. In the exemplary embodiment, as depicted, calculating forecasted revenue projections 428 requires three necessary inputs: expected backlog revenue 422, attrition impact 424, and skew impact 426.

The foregoing description of various embodiments of the present invention has been presented for purposes of illustration and description. It is not intended to be exhaustive or to limit the invention to the precise form disclosed. Many modifications and variations are possible. Such modifications and variations that may be apparent to a person skilled in the art of the invention are intended to be included within the scope of the invention as defined by the accompanying claims.

FIG. 5 depicts a block diagram of components of computing device 110, in accordance with an illustrative embodiment. It should be appreciated that FIG. 5 provides only an illustration of one implementation and does not imply any limitations with regard to the environment in which different embodiments may be implemented. Many modifications to the depicted environment may be made.

Computing device 110 includes communications fabric 502, which provides communications between computer processor(s) 504, memory 506, persistent storage 508, communications unit 512, and input/output (I/O) interface(s) 514.

Memory 506 and persistent storage 508 are examples of computer-readable tangible storage devices and media. Memory 506 may be, for example, one or more random access memories (RAM) 516, cache 518, or any other suitable volatile or non-volatile storage device.

Programs, such as PA tool 114 and user interface 112, are stored in persistent storage 508 for execution by one or more of the respective computer processors 504 via one or more memories of memory 506. In the embodiment, persistent storage 508 includes flash memory. Alternatively, or in addition to flash memory, persistent storage 508 may include a magnetic disk storage device of an internal hard drive, a solid state drive, a semiconductor storage device, read-only memory (ROM), EPROM, or any other computer-readable tangible storage device that is capable of storing program instructions or digital information.

The media used by persistent storage 508 may also be removable. For example, a removable hard drive may be used for persistent storage 508. Other examples include an optical or magnetic disk that is inserted into a drive for transfer onto another storage device that is also a part of persistent storage 508, or other removable storage devices such as a thumb drive or smart card.

Communications unit 512, in these examples, provides for communications with other data processing systems or devices. In these examples, communications unit 512 includes one or more network interface cards. Communications unit 512 may provide communications through the use of either or both physical and wireless communications links. Programs, such as PA tool 114, may be downloaded to persistent storage 508 through communications unit 512.

I/O interface(s) 514 allows for input and output of data with other devices that may be connected to computing device 110. For example, I/O interface 514 may provide a connection to external devices 520 such as a keyboard, keypad, a touch screen, and/or some other suitable input device. I/O interface(s) may also connect to display 522.

Display 522 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for projecting maintenance revenue, comprising the steps of:
a computing device receiving a first user input requesting an estimated revenue for a projected time period, wherein the projected time period is a time period which is subsequent to a base time period;
the computing device receiving a second user input, wherein the second user input includes: a current number of installed units as of the base time period, an expected number of unit installations for one or more subsequent time periods to the base time period, a warranty upgrade rate, a warranty capture rate, an attrition rate, and a maintenance contract renewal rate;
the computing device determining an expected revenue for the projected time period from new maintenance contracts and renewed maintenance contracts based on at least the current number of installed units as of the base time period, the expected number of unit installations for the projected time period, the attrition rate, the warranty capture rate, and the maintenance contract renewal rate;
the computing device determining an expected revenue for the projected time period from warranty upgrades on units based on at least the current number of installed units as of the base time period, the expected number of unit installations for the projected time period, the attrition rate and the warranty option upgrade rate; and
the computing device determining a total expected revenue for the projected time period based on at least the computing device determining the expected revenue for the projected time period from new maintenance contracts and renewed maintenance contracts and the expected revenue for the projected time period from warranty upgrades on installed units.

2. The method of claim 1, wherein the step of determining the total expected revenue for the projected time period is further based on one or more of: a general price action value and a discount value.

3. The method of claim 1, wherein the step of determining the total expected revenue for the projected time period is further based on one or more of: a general price action skew value and a discount skew value.

4. The method of claim 1, wherein the step of determining the total expected revenue for the projected time period is further based on a signing skew value for the projected year.

5. The method of claim 1, wherein the second user input further includes one or more of: a general price action value, a discount value, a signing skew value, an average annual revenue per unit, and an average annual revenue from warranty upgrade per unit.

6. The method of claim 1, the method further comprising determining a total expected revenue flowing into the projected time period from the base time period and a total expected revenue flowing into the projected time period from each time period between the base time period and the projected time period.

7. A computer program product for projecting maintenance revenue, the computer program product comprising:
one or more computer-readable storage devices and program instructions stored on at least one of the one or more tangible storage devices, the program instructions comprising:
program instructions to receive a first user input requesting an estimated revenue for a projected time period, wherein the projected time period is a time period which is subsequent to a base time period;
program instructions to receive a second user input, wherein the second user input includes: a current number of installed units as of the base time period, an expected number of unit installations for one or more subsequent time periods to the base time period, a warranty upgrade rate, a warranty capture rate, an attrition rate, and a maintenance contract renewal rate;
program instructions to determine an expected revenue for the projected time period from new maintenance contracts and renewed maintenance contracts based on at least the current number of installed units as of the base time period, the expected number of unit installations for the projected time period, the attrition rate, the warranty capture rate, and the maintenance contract renewal rate;
program instructions to determine an expected revenue for the projected time period from warranty upgrades on units based on at least the current number of installed units as of the base time period, the expected number of unit installations for the projected time period, the attrition rate and the warranty option upgrade rate; and
program instructions to determine a total expected revenue for the projected time period based on at least the computing device determining the expected revenue for the projected time period from new maintenance contracts and renewed maintenance contracts and the expected revenue for the projected time period from warranty upgrades on installed units.

8. The computer program product of claim 7, wherein the program instructions to determine the total expected revenue for the projected time period is further based on one or more of: a general price action value and a discount value.

9. The computer program product of claim 7, wherein the program instructions to determine the total expected revenue for the projected time period is further based on one or more of: a general price action skew value and a discount skew value.

10. The computer program product of claim 7, wherein the program instructions to determine the total expected revenue for the projected time period is further based on a signing skew value for the projected year.

11. The computer program product of claim 7, wherein the second user input further includes one or more of: a general price action value, a discount value, a signing skew value, an average annual revenue per unit, and an average annual revenue from warranty upgrade per unit.

12. The computer program product of claim 7, further comprising program instructions to determine a total expected revenue flowing into the projected time period from the base time period and a total expected revenue flowing into the projected time period from each time period between the base time period and the projected time period.

13. A computer system for projecting maintenance revenue, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive a first user input requesting an estimated revenue for a projected time period, wherein the projected time period is a time period which is subsequent to a base time period;
program instructions to receive a second user input, wherein the second user input includes: a current number of installed units as of the base time period, an expected number of unit installations for one or more subsequent time periods to the base time period, a warranty upgrade rate, a warranty capture rate, an attrition rate, and a maintenance contract renewal rate;
program instructions to determine an expected revenue for the projected time period from new maintenance contracts and renewed maintenance contracts based on at least the current number of installed units as of the base time period, the expected number of unit installations for the projected time period, the attrition rate, the warranty capture rate, and the maintenance contract renewal rate;
program instructions to determine an expected revenue for the projected time period from warranty upgrades on units based on at least the current number of installed units as of the base time period, the expected number of unit installations for the projected time period, the attrition rate and the warranty option upgrade rate; and
program instructions to determine a total expected revenue for the projected time period based on at least the computing device determining the expected revenue for the projected time period from new maintenance contracts and renewed maintenance contracts and the expected revenue for the projected time period from warranty upgrades on installed units.

14. The computer system of claim 13, wherein the program instructions to determine the total expected revenue for the projected time period is further based on one or more of: a general price action value and a discount value.

15. The computer system of claim 13, wherein the program instructions to determine the total expected revenue for the projected time period is further based on one or more of: a general price action skew value and a discount skew value.

16. The computer system of claim 13, wherein the program instructions to determine the total expected revenue for the projected time period is further based on a signing skew value for the projected year.

17. The computer system of claim 13, wherein the second user input further includes one or more of: a general price action value, a discount value, a signing skew value, an average annual revenue per unit, and an average annual revenue from warranty upgrade per unit.

18. The computer system of claim 13, further comprising program instructions to determine a total expected revenue flowing into the projected time period from the base time period and a total expected revenue flowing into the projected time period from each time period between the base time period and the projected time period.
